(19) United States
(12) Patent Application Publication
(10) Pub. No.: US 2025/0316161 A1
(43) Pub. Date: Oct. 9, 2025

(54) METHODS AND SYSTEMS FOR ESTIMATING TRAFFIC JAM LANE USING LANE CONNECTIVITY DATA

(71) Applicant: Toyota Motor Engineering & Manufacturing North America, Inc., Plano, TX (US)

(72) Inventors: Yashar Zeiynali Farid, San Jose, CA (US); Emrah Akin Sisbot, Menlo Park, CA (US); Divya Sai Toopran, San Jose, CA (US); Kentaro Oguchi, Sunnyvale, CA (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/626,711

(22) Filed: Apr. 4, 2024

(51) Int. Cl. G08G 1/01; G01C 21/00

(52) U.S. Cl. CPC G08G 1/0125; G01C 21/3807; G08G 1/0112; G08G 1/0141

(57) ABSTRACT

A system for estimating lane-level traffic jam is provided. The system includes one or more processors programmed to: obtain a first road link, a second road link connected to the first road link, and a third road link connected to the first road link based on a map; identify a traffic jam section in the first road link based on driving data of vehicles; generate an initial lane-level traffic jam distribution in the first road link; update the initial lane-level traffic jam distribution in the first road link based on traffic jam information on the second road link and the third road link; and transmit the lane-level traffic jam distribution to vehicles approaching the traffic jam section.

### TECHNICAL FIELD

The present specification relates to systems and methods for estimating lane-level traffic jam, and more particularly, estimating lane-level traffic jam using lane connectivity data.

### BACKGROUND

Lane-level traffic, in which average speed of vehicles in different lanes vary, can increase crash risk, especially rear-end crashes. In addition, if there are different traffic levels in different levels, drivers may miss the back of a traffic jam queue and try to cut in. Existing navigation systems do not provide lane-level traffic. For example, when an exit to the right is congested, the existing navigation systems do not show the congested right lane, and show the whole road section without traffic due to driving data of vehicles that drive in normal speeds in other lanes.

Accordingly, a need exists for systems and methods for accurately estimating lane-level traffic information.

### SUMMARY

The present disclosure provides systems and methods for estimating lane-level traffic jam using lane change signals of connected vehicles.

In one embodiment, a system for estimating lane-level traffic jam is provided. The system includes one or more processors programmed to: obtain a first road link, a second road link connected to the first road link, and a third road link connected to the first road link based on a map; identify a traffic jam section in the first road link based on driving data of vehicles; generate an initial lane-level traffic jam distribution in the first road link; update the initial lane-level traffic jam distribution in the first road link based on traffic jam information on the second road link and the third road link; and transmit the lane-level traffic jam distribution to vehicles approaching the traffic jam section

In another embodiment, a method for determining lane-level traffic is provided. The method includes obtaining a first road link, a second road link connected to the first road link, and a third road link connected to the first road link based on a map; identifying a traffic jam section in the first road link based on driving data of vehicles; generating an initial lane-level traffic jam distribution in the first road link; updating the initial lane-level traffic jam distribution in the first road link based on traffic jam information on the second road link and the third road link; and transmitting the lane-level traffic jam distribution to vehicles approaching the traffic jam section.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1A schematically depicts a system for estimating lane-level traffic jam using lane connectivity data, according to one or more embodiments shown and described herein;

FIG. 1B depicts estimating a probability of traffic jam in each of the lanes using lane connectivity data, according to one or more embodiments shown and described herein;

FIC. 1C illustrates an example lane-level traffic distribution image for a road, according to one or more embodiments shown and described herein;

FIG. 1D depicts estimating a probability of traffic jam in each of the lanes using lane connectivity data, according to one or more embodiments shown and described herein;

FIG. 2 schematically depicts a system for estimating lane-level traffic jam using lane connectivity data, according to one or more embodiments shown and described herein;

FIG. 3 depicts a flowchart for estimating lane-level traffic jam, according to one or more embodiments shown and described herein;

FIG. 4A depicts estimating a probability of traffic jam in each of the lanes using routes of connected vehicles, according to one or more embodiments shown and described herein;

FIG. 4B depicts estimating a probability of traffic jam in each of the lanes using routes of connected vehicles, according to one or more embodiments shown and described herein;

FIG. 5 depicts estimating a probability of traffic jam in each of the lanes using lane connectivity information and lane change signals of connected vehicles, according to one or more embodiments shown and described herein;

FIG. 6 depicts estimating a probability of traffic jam in each of the lanes using lane connectivity information and lane change signals of connected vehicles, according to one or more embodiments shown and described herein; and

FIG. 7 depicts estimating a probability of traffic jam in each of the lanes using lane connectivity information and lane change signals of connected vehicles, according to one or more embodiments shown and described herein.

### DETAILED DESCRIPTION

The embodiments disclosed herein include systems and methods for estimating lane-level traffic jam, according to one or more embodiments shown and described herein. In particular, as used herein, the lane-level traffic jam indicates a situation where the average speed of vehicles in one lane of a road is substantially different from the average speed of vehicles in another lane of the road. More specifically, the lane-level traffic jam may indicate a situation in which the average speed of vehicles in one lane of a road in a particular region varies by more than a threshold amount from the average speed of vehicles in another lane of the road within the particular region.

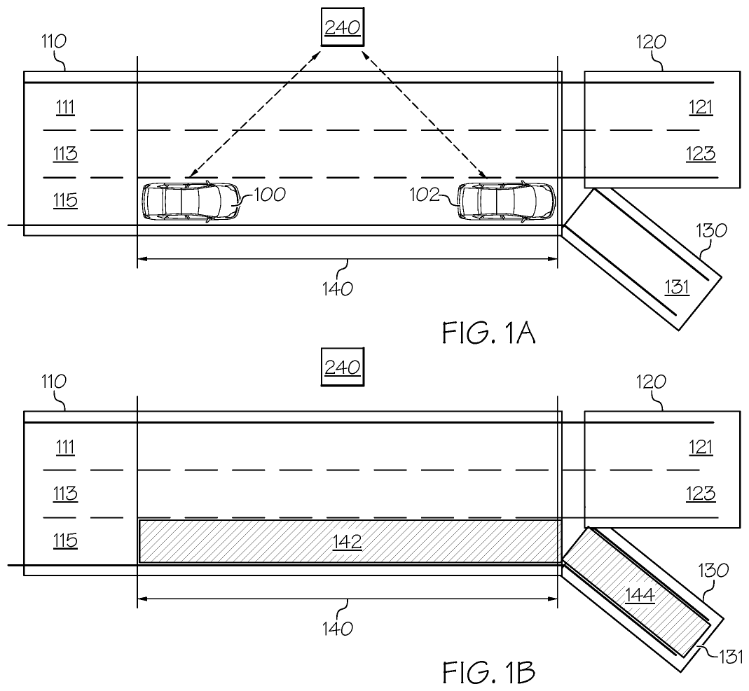

As illustrated in FIG. 1A, a server obtains a first road link 110, a second road link 120 connected to the first road link 110, and a third road link 130 connected to the first road link 110 based on a map. The server identifies a traffic jam section 140 in the first road link 110 based on driving data of vehicles in the first road link 110. The server 240 generates an initial lane-level traffic jam distribution in the first road link 110, e.g., each lane of the first road link 110 has 33% of having a traffic jam therein. The server 240 updates the initial lane-level traffic jam distribution in the first road link 110 based on traffic jam information on the second road link 120 and the third road link 130. For example, if the third road link 130 has a traffic jam section therein and the second road link 120 does not have a traffic jam section therein, the server 240 estimates that the lane 115 of the first road link 110 that is connected to the lane 131 of the third road link 130 has relatively high probability of having a traffic jam therein and estimates that the lanes 111 and 113 of the first road link 110 that are connected to the lanes 121 and 123 of the second road link 120 have relatively low probability of having a traffic jam therein. Based on the estimation, the server 240 updates the initial lane-level traffic jam distribution. Then, the server 240 transmits the updated lane-level traffic jam distribution to vehicles approaching the traffic jam section 140.

According to the present disclosure, the present system identifies lane ID of a traffic jam by analyzing lane connectivity data and/or vehicle route information. The present system identifies the lane ID of a traffic jam without requiring lane IDs of vehicles.

FIG. 1A schematically depicts a system for estimating lane-level traffic jam using lane connectivity data, according to one or more embodiments shown and described herein. In embodiments, a system includes first and second connected vehicles 100 and 102, and a server 240. The server 240 may be a local server including, but not limited to, roadside unit, an edge server, and the like. In some embodiments, the server 240 may be a remote server such as a cloud server.

Each of the first and second connected vehicles 100 and 102 may be a vehicle including an automobile or any other passenger or non-passenger vehicle such as, for example, a terrestrial, aquatic, and/or airborne vehicle. In some embodiments, one or more of the first and second connected vehicles 100 and 102 may be an unmanned aerial vehicle (UAV), commonly known as a drone.

The first and second connected vehicles 100 and 102 may be autonomous and connected vehicles, each of which navigates its environment with limited human input or without human input. The first and second connected vehicles 100 and 102 are equipped with internet access and share data with other devices both inside and outside the first and second connected vehicles 100 and 102. Each of the first and second connected vehicles 100 and 102 may include an actuator such as an engine, a motor, and the like to drive the vehicle. The first and second connected vehicles 100 and 102 may communicate with the server 240. The server 240 may communicate with vehicles in an area covered by the server 240. The server 240 may communicate with other servers that cover different areas. The server 240 may communicate with a remote server and transmit information collected by the server 240 to the remote server.

In FIG. 1A, the connected vehicles 100 and 102 are traveling on a first road link 110 including multiple lanes, e.g., lanes 111, 113, and 115. The first road link 110 is connected to the second road link 120 and the third road link 130. The second road link 120 includes lanes 121 and 123 and the third road link 130 includes a single lane 131. The connected vehicles 100 and 102 transmit to the server 240 their driving data that include, but not limited to, the locations, speeds, radial accelerations, orientations, wheel angles, blinker states and the like. While FIG. 1A depicts two connected vehicles 100 and 102, the server 240 may receive driving data from more than the two connected vehicles 100 and 102. Based on the driving data from connected vehicles, particularly, the speed of the connected vehicles, the server 240 may identify a traffic jam section 140 in the first road link 110.

The connected vehicles 100 and 102 may not be equipped with high precision GPS sensors, such that the connected vehicles 100 and 102 may not know which lane they are driving in. For example, the connected vehicle 100 may have information that it is driving on the first road link 110, however, the connected vehicle 100 is not certain which of the lanes 111, 113, and 115 the connected vehicle 100 is taking. Similarly, the connected vehicle 102 is not certain about information on the lane-level trajectory. Thus, when the connected vehicles 100 and 102 transmit their driving data to the server 240, the driving data do not include lane ID information, i.e., the identification of the lane in which corresponding vehicle is driving. In this regard, although the server 240 may identify the traffic jam section 140, the server 240 cannot identify which lane includes a traffic jam and which lane does not include a traffic jam among the lanes 111, 113, and 115.

In embodiments, the system may estimate lane-level traffic jam status using lane connectivity data and traffic jam information in different road links. FIG. 1B depicts estimating a probability of traffic jam in each of the lanes using lane connectivity data, according to one or more embodiments shown and described herein.

In FIG. 1B, the server 240 may generate lane connectivity graph which is used to identify the next and previous lanes connected to a specific lane. For example, in FIG. 1B, the lane connectivity graph indicates that the lane 115 of the first road link 110 is connected to the lane 131 of the third road link 130, and the lane connectivity graph indicates that the lanes 111 and 113 are connected to lanes 121 and 123 of the second road link 120. The server may estimate jam dynamics such as the front and back position of a traffic jam section and average speed of vehicles in a traffic jam using data received from connected vehicles and matched positions of vehicles on a map. The estimated jam dynamics may indicate that the first road link 110 has a traffic jam close to the end of the first road link 110.

Then, the server 240 may generate an initial lane-level jam distribution for the first road link 110. Because there are three lanes 111, 113, 115, the initial lane-level jam distribution would have a uniform distribution as [0.33, 0.33, 0.33] which means the traffic jam can be in each lane with 33% probability. The server 240 determines that there is a traffic jam near the beginning of the third road link 130 based on driving data received from vehicles in the third road link 130. Because the third road link 130 has only one lane, the lane-level jam distribution would be [1.0].

The server may determine that the second road link 120 does not have a traffic jam near the beginning of the second road link 120 based on driving data received from vehicles in the second road link 120. The lane-level jam distribution for the second road link 120 would be [0.05, 0.05], which means each of the lanes 121 and 123 has 5% probability of having a traffic jam therein.

Using lane connectivity information obtained from a map, the server 240 calculates the probability of traffic jam being in an i-th lane using Equation 1 below.

$$i - th lane probability = γ * initial probability * next lane weight \qquad Equation 1$$

Where γ is weight parameter (e.g., γ=0.7), and the next lane weight is the probability of traffic jam being in the next lane connected to the i-th lane.

For example, for the lane 111, the initial probability of traffic jam being in the lane 111 is 0.33. The next lane weight is the probability of traffic jam being in the lane 121, which is 0.05. Thus, the probability of traffic jam being in the lane 111 is 0.7*0.33*0.05=0.01. Similarly, for the lane 113, the initial probability of traffic jam being in the lane 113 is 0.33. The next lane weight is the probability of traffic jam being in the lane 123, which is 0.05. Thus, the probability of traffic jam being in the lane 113 is 0.7*0.33*0.05=0.01. For the lane 115, the initial probability of traffic jam being in the lane 115 is 0.33. The next lane weight is the probability of traffic jam being in the lane 131, which is 1. Thus, the probability of traffic jam being in the lane 115 is 0.7*0.33*1.0=0.23. Because the sum of probabilities needs to be 1, the server 240 pads and normalizes the computed probabilities of [0.01, 0.01, 0.23] and obtains updated lane-level jam distribution of [0.04, 0.04, 0.92].

The server 240 may transmit information about the updated lane-level traffic jam distribution to connected vehicles. In embodiments, the server 240 may transmit the information about the updated lane-level traffic jam distribution to connected vehicles approaching the traffic jam section 140, and the connected vehicles approaching the traffic jam section 140 may autonomously drive to divert the lane having a traffic jam. For example, if connected vehicles approaching the traffic jam section 140 are driving in the lane 115, the connected vehicles may change lanes to the left in advance to avoid being trapped in the traffic jam 142.

In some embodiments, the connected vehicles that received the updated lane-level traffic jam distribution from the server 240 may display lane-level traffic jam distribution on an output device, for example, the head-unit of the vehicle, or the navigation app of the smartphone of a user in the vehicle, as illustrated in FIG. 1C. FIC. 1C illustrates an example lane-level traffic distribution image for the first road link 110. The lane 111 includes the bar 151 and the lane 113 includes the bar 153. The bars 151 and 153 indicate lane without a traffic jam. The lane 115 includes the bars 155 and 157. The bar 155 indicates a traffic jam, the bar 157 indicates a relatively slow driving section.

FIG. 1D depicts estimating a probability of traffic jam in each of the lanes using lane connectivity data, according to one or more embodiments shown and described herein. In FIG. 1D, the server 240 may generate lane connectivity graph which is used to identify the next and previous lanes connected to a specific lane. For example, in FIG. 1D, the lane connectivity graph indicates that the lane 131 of the third road link 130 is connected to the lane 115 of the first road link 110, and the lane connectivity graph indicates that the lanes 121 and 123 of the second road link 120 are connected to the lanes 111 and 113 of the first road link 110. The server 240 may estimate jam dynamics such as the front and back position of a traffic jam section and average speed of vehicles in a traffic jam using data received from connected vehicles and matched positions of vehicles on a map. The estimated jam dynamics may indicate that the back of the traffic jam section is close to the beginning of the first road link 110.

Then, the server 240 may generate an initial lane-level jam distribution for the first road link 110. Because there are three lanes 111, 113, 115, the initial lane-level jam distribution would have a uniform distribution as [0.33, 0.33, 0.33] which means the traffic jam can be on each lane with 33% probability. The server 240 determines that there is a traffic jam near the end of the third road link 130 based on driving data received from vehicles in the third road link 130. Because the third road link 130 has only one lane, the lane-level jam distribution would be [1.0].

The server may determine that the second road link 120 does not have a traffic jam near the end of the second road link 120 based on driving data received from vehicles in the second road link 120. The lane-level jam distribution for the second road link 120 would be [0.05, 0.05].

Using lane connectivity information obtained from a map, the server 240 calculates the probability of traffic jam being in a lane using Equation 1 above, and obtains updated lane-level jam distribution of [0.04, 0.04, 0.92], which indicates that the lane 115 has the highest probability of having a traffic jam therein.

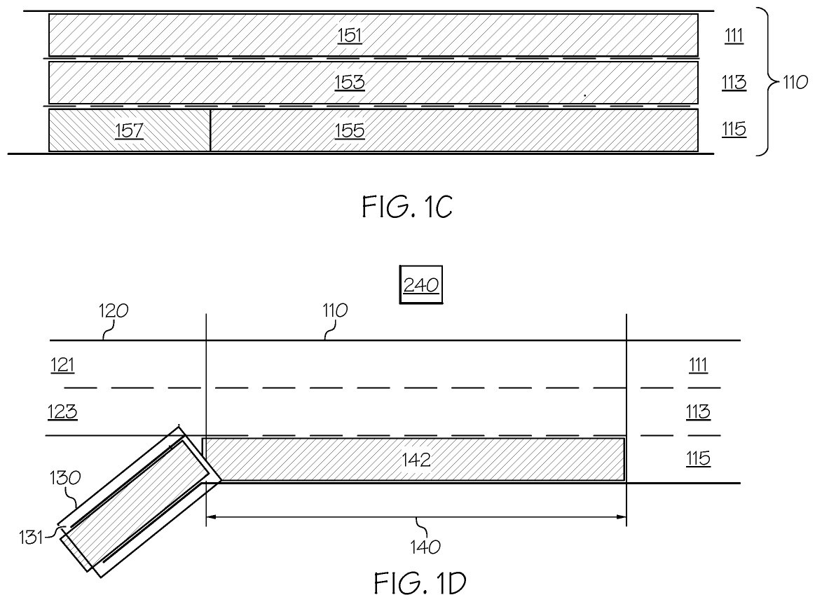

FIG. 2 schematically depicts a system for estimating lane-level traffic jam using lane connectivity data, according to one or more embodiments shown and described herein. The system for estimating traffic jam lane includes a first connected vehicle system 200, a second connected vehicle system 220, and a server 240.

It is noted that, while the first connected vehicle system 200 and the second connected vehicle system 220 are depicted in isolation, each of the first connected vehicle system 200 and the second connected vehicle system 220 may be included within a vehicle in some embodiments, for example, respectively within each of the connected vehicles 100 and 102 of FIG. 1A. In embodiments in which each of the first connected vehicle system 200 and the second connected vehicle system 220 is included within a vehicle, the vehicle may be an automobile or any other passenger or non-passenger vehicle such as, for example, a terrestrial, aquatic, and/or airborne vehicle. In some embodiments, the vehicle is an autonomous vehicle that navigates its environment with limited human input or without human input.

The first connected vehicle system 200 includes one or more processors 202. Each of the one or more processors 202 may be any device capable of executing machine readable and executable instructions. Accordingly, each of the one or more processors 202 may be a controller, an integrated circuit, a microchip, a computer, or any other computing device. The one or more processors 202 are coupled to a communication path 204 that provides signal interconnectivity between various modules of the system. Accordingly, the communication path 204 may communicatively couple any number of processors 202 with one another, and allow the modules coupled to the communication path 204 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 204 may be formed from any medium that is capable of transmitting a signal such as, for example, conductive wires, conductive traces, optical waveguides, or the like. In some embodiments, the communication path 204 may facilitate the transmission of wireless signals, such as WiFi, Bluetooth®, Near Field Communication (NFC) and the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The first connected vehicle system 200 includes one or more memory modules 206 coupled to the communication path 204. The one or more memory modules 206 may comprise RAM, ROM, flash memories, hard drives, or any device capable of storing machine readable and executable instructions such that the machine readable and executable instructions can be accessed by the one or more processors 202. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 206. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

The one or more memory modules 206 may include machine readable instructions that, when executed by the one or more processors 202 identify a traffic jam section based on driving data of vehicles; obtain a first road link including the traffic jam section and a second road link and a third road link connected to the first road link based on a map; generate an initial lane-level traffic jam distribution in the first road link; update the initial lane-level traffic jam distribution in the first road link based on traffic jam information on the second road link and the third road link; and transmit the lane-level traffic jam distribution to vehicles approaching the traffic jam section.

Referring still to FIG. 2, the first connected vehicle system 200 comprises one or more sensors 208. The one or more sensors 208 may be any device having an array of sensing devices capable of detecting radiation in an ultraviolet wavelength band, a visible light wavelength band, or an infrared wavelength band. The one or more sensors 208 may have any resolution. In some embodiments, one or more optical components, such as a mirror, fish-eye lens, or any other type of lens may be optically coupled to the one or more sensors 208. In some embodiments, the one or more sensors 208 may also provide navigation support. That is, data captured by the one or more sensors 208 may be used to autonomously or semi-autonomously navigate the connected vehicle 100.

In some embodiments, the one or more sensors 208 include one or more imaging sensors configured to operate in the visual and/or infrared spectrum to sense visual and/or infrared light. Additionally, while the particular embodiments described herein are described with respect to hardware for sensing light in the visual and/or infrared spectrum, it is to be understood that other types of sensors are contemplated. For example, the systems described herein could include one or more LIDAR sensors, radar sensors, sonar sensors, or other types of sensors and that such data could be integrated into or supplement the data collection described herein to develop a fuller real-time traffic image. Ranging sensors like radar may be used to obtain a rough depth and speed information for the view of the first connected vehicle system 200. The first connected vehicle system 200 may capture road boundaries, static objects, moving objects, and the like using one or more imaging sensors.

In operation, the one or more sensors 208 capture image data and communicate the image data to the one or more processors 202 and/or to other systems communicatively coupled to the communication path 204. The image data may be received by the one or more processors 202, which may process the image data using one or more image processing algorithms. Any known or yet-to-be developed video and image processing algorithms may be applied to the image data in order to identify an item or situation. Example video and image processing algorithms include, but are not limited to, kernel-based tracking (such as, for example, mean-shift tracking) and contour processing algorithms. In general, video and image processing algorithms may detect objects and movement from sequential or individual frames of image data. One or more object recognition algorithms may be applied to the image data to extract objects and determine their relative locations to each other. Any known or yet-to-be-developed object recognition algorithms may be used to extract the objects or even optical characters and images from the image data. Example object recognition algorithms include, but are not limited to, scale-invariant feature transform (“SIFT”), speeded up robust features (“SURF”), and edge-detection algorithms.

The first connected vehicle system 200 comprises a satellite antenna 214 coupled to the communication path 204 such that the communication path 204 communicatively couples the satellite antenna 214 to other modules of the first connected vehicle system 200. The satellite antenna 214 is configured to receive signals from global positioning system satellites. Specifically, in one embodiment, the satellite antenna 214 includes one or more conductive elements that interact with electromagnetic signals transmitted by global positioning system satellites. The received signal is transformed into a data signal indicative of the location (e.g., latitude and longitude) of the satellite antenna 214 or an object positioned near the satellite antenna 214, by the one or more processors 202.

The first connected vehicle system 200 comprises one or more vehicle sensors 212. Each of the one or more vehicle sensors 212 is coupled to the communication path 204 and communicatively coupled to the one or more processors 202. The one or more vehicle sensors 212 may include one or more motion sensors for detecting and measuring the orientation, acceleration, motion and changes in motion of the vehicle. The motion sensors may include inertial measurement units. Each of the one or more motion sensors may include one or more accelerometers and one or more gyroscopes. Each of the one or more motion sensors transforms sensed physical movement of the vehicle into a signal indicative of an orientation, a rotation, a velocity, or an acceleration of the vehicle. The one or more vehicle sensors 212 may include wheel sensors for detecting wheel angles.

Still referring to FIG. 2, the first connected vehicle system 200 comprises network interface hardware 216 for communicatively coupling the first connected vehicle system 200 to the second connected vehicle system 220 and/or the server 240. The network interface hardware 216 can be communicatively coupled to the communication path 204 and can be any device capable of transmitting and/or receiving data via a network. Accordingly, the network interface hardware 216 can include a communication transceiver for sending and/or receiving any wired or wireless communication. For example, the network interface hardware 216 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the network interface hardware 216 includes hardware configured to operate in accordance with the Bluetooth® wireless communication protocol. The network interface hardware 216 of the first connected vehicle system 200 may transmit its data to the server 240. For example, the network interface hardware 216 of the first connected vehicle system 200 may transmit captured point cloud generated by the first connected vehicle system 200, vehicle data, location data, and the like to other connected vehicles or the server 240.

The first connected vehicle system 200 may connect with one or more external vehicles and/or external processing devices (e.g., the server 240) via a direct connection. The direct connection may be a vehicle-to-vehicle connection (“V2V connection”) or a vehicle-to-everything connection (“V2X connection”). The V2V or V2X connection may be established using any suitable wireless communication protocols discussed above. A connection between vehicles may utilize sessions that are time-based and/or location-based. In embodiments, a connection between vehicles or between a vehicle and an infrastructure element may utilize one or more networks to connect (e.g., the network 250), which may be in lieu of, or in addition to, a direct connection (such as V2V or V2X) between the vehicles or between a vehicle and an infrastructure. By way of non-limiting example, vehicles may function as infrastructure nodes to form a mesh network and connect dynamically on an ad-hoc basis. In this way, vehicles may enter and/or leave the network at will, such that the mesh network may self-organize and self-modify over time. Other non-limiting network examples include vehicles forming peer-to-peer networks with other vehicles or utilizing centralized networks that rely upon certain vehicles and/or infrastructure elements. Still other examples include networks using centralized servers and other central computing devices to store and/or relay information between vehicles.

Still referring to FIG. 2, the first connected vehicle system 200 may be communicatively coupled to the server 240 by the network 250. In one embodiment, the network 250 may include one or more computer networks (e.g., a personal area network, a local area network, or a wide area network), cellular networks, satellite networks and/or a global positioning system and combinations thereof. Accordingly, the first connected vehicle system 200 can be communicatively coupled to the network 250 via a wide area network, via a local area network, via a personal area network, via a cellular network, via a satellite network, etc. Suitable local area networks may include wired Ethernet and/or wireless technologies such as, for example, wireless fidelity (Wi-Fi). Suitable personal area networks may include wireless technologies such as, for example, IrDA, Bluetooth®, Wireless USB, Z-Wave, ZigBee, and/or other near field communication protocols. Suitable cellular networks include, but are not limited to, technologies such as LTE, WiMAX, UMTS, CDMA, and GSM.

Still referring to FIG. 2, the server 240 includes one or more processors 242, one or more memory modules 246, network interface hardware 248, and a communication path 244. The one or more processors 242 may be a controller, an integrated circuit, a microchip, a computer, or any other computing device. The one or more memory modules 246 may comprise RAM, ROM, flash memories, hard drives, or any device capable of storing machine readable and executable instructions such that the machine readable and executable instructions can be accessed by the one or more processors 242. The communication path 244 may be similar to the communication path 204 in some embodiments.

The one or more memory modules 246 may include machine readable instructions that, when executed by the one or more processors 242, identify a traffic jam section based on driving data of vehicles; obtain a first road link including the traffic jam section and a second road link and a third road link connected to the first road link based on a map; generate an initial lane-level traffic jam distribution in the first road link; update the initial lane-level traffic jam distribution in the first road link based on traffic jam information on the second road link and the third road link; and transmit the lane-level traffic jam distribution to vehicles approaching the traffic jam section.

Still referring to FIG. 2, the second connected vehicle system 220 includes one or more processors 222, one or more memory modules 226, one or more sensors 228, one or more vehicle sensors 232, a satellite antenna 234, network interface hardware 236, and a communication path 224 communicatively connected to the other components of the second connected vehicle system 220. The components of the second connected vehicle system 220 may be structurally similar to and have similar functions as the corresponding components of the first connected vehicle system 200 (e.g., the one or more processors 222 corresponds to the one or more processors 202, the one or more memory modules 226 corresponds to the one or more memory modules 206, the one or more sensors 228 corresponds to the one or more sensors 208, the one or more vehicle sensors 232 corresponds to the one or more vehicle sensors 212, the satellite antenna 234 corresponds to the satellite antenna 214, the network interface hardware 236 corresponds to the network interface hardware 216, and the communication path 224 corresponds to the communication path 204).

The one or more memory modules 226 may include machine readable instructions that, when executed by the one or more processors 222, identify a traffic jam section based on driving data of vehicles; obtain a first road link including the traffic jam section and a second road link and a third road link connected to the first road link based on a map; generate an initial lane-level traffic jam distribution in the first road link; update the initial lane-level traffic jam distribution in the first road link based on traffic jam information on the second road link and the third road link; and transmit the lane-level traffic jam distribution to vehicles approaching the traffic jam section.

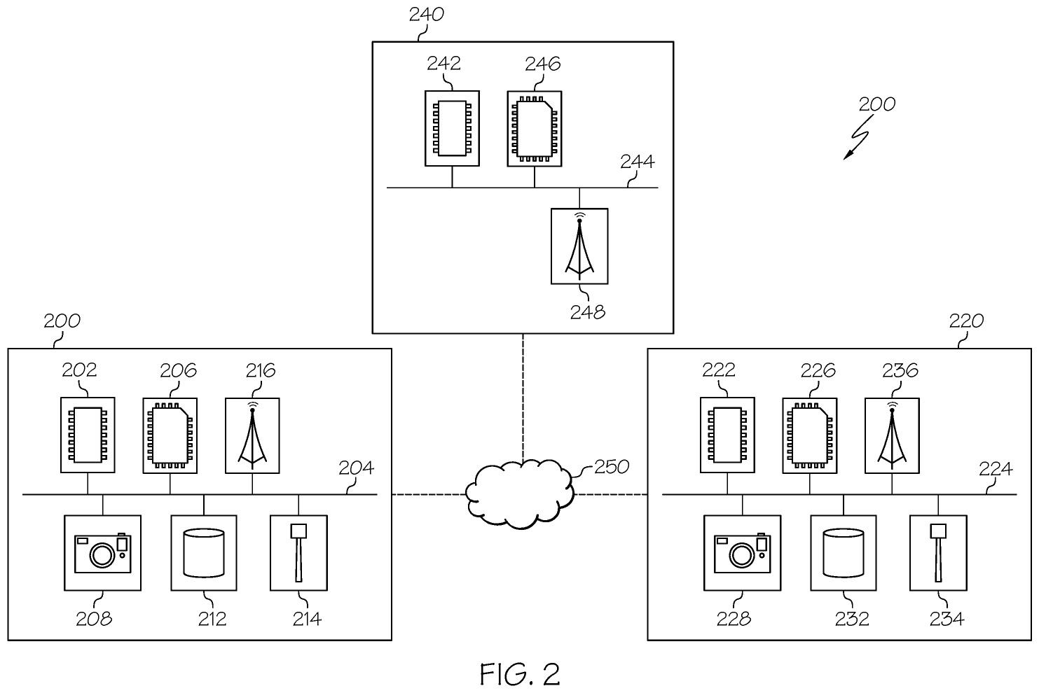

FIG. 3 depicts a flowchart for estimating lane-level traffic jam, according to one or more embodiments shown and described herein.

In step 310, a server obtains a first road link, a second road link connected to the first road link, and a third road link connected to the first road link based on a map. In embodiments, the server may generate a lane connectivity graph for identifying next and previous lanes connected to a specific lane. By referring to FIG. 1A, the server 240 may obtain the first road link 110, the second road link 120, and the third road link 130 from map data. The map data may include information that the first road link 110 includes three lanes 111, 113, 115, the second road link 120 includes two lanes 121 and 123, and the third road link 130 includes one lane 131. The map data include information that the lanes 121 and 123 are connected to the lanes 111 and 113, respectively, and the lane 131 is connected to the lane 115.

Referring back to FIG. 3, the server identifies a traffic jam area in the first road link based on driving data of vehicles. By referring to FIG. 1A, the server 240 may receive driving data from connected vehicles such as the connected vehicles 100 and 102 in the first road link 110, connected vehicles in the second road link 120, and connected vehicles in the third road link 130.

Regarding the first road link 110, based on the driving data including the speeds of connected vehicles in the first road link 110, the server 240 may identify the traffic jam section 140 in the first road link 110. Specifically, the server 240 may detect the front and back of the traffic jam section 140 based on the speeds of the connected vehicles and identify the traffic jam section 140 spanning from the front to the back. For example, the front of the traffic jam may be the location of a connected vehicle that is located at the front among the connected vehicles whose speed is less than a threshold speed, e.g., 5 mph, 10 mph, 20 mph, etc. The back of the traffic jam may be the location of a connected vehicle that is located at the back among the connected vehicles whose speed is less than a threshold speed, e.g., 5 mph, 10 mph, 20 mph, etc.

Regarding the second road link 120, the server 240 may determine that there is no traffic jam at the beginning of the second road link 120 based on the speeds of vehicles that are at the beginning of the second road link 120. Regarding the third road link 130, the server 240 may identify the traffic jam section 144 in the third road link 130. Specifically, the server 240 may detect the front and back of the traffic jam section 144 based on the speeds of the connected vehicles and identify the traffic jam section 144 spanning from the front to the back.

Referring back to FIG. 3, in step 330, the server may generate an initial lane-level traffic jam distribution in the first road link. By referring to FIG. 1A, the server 240 may estimate lane-level traffic jam distribution that includes a probability of traffic jam in each of the lanes 111, 113, 115. The server 240 may generate an initial lane-level traffic jam distribution that may have equal probability of having a traffic jam in each of the lanes 111, 113, 115, i.e., [0.33, 0.33, 0.33].

Referring back to FIG. 3, in step 340, the server may update the initial lane-level traffic jam distribution in the first road link based on traffic jam information on the second road link and the third road link.

By referring to FIG. 1B, the server may determine that the second road link 120 does not have a traffic jam near the beginning of the second road link 120 based on driving data received from vehicles in the second road link 120. The lane-level jam distribution for the second road link 120 would be [0.05, 0.05]. The server 240 determines that there is a traffic jam near the beginning of the third road link 130 based on driving data received from vehicles in the third road link 130. Because the third road link 130 has only one lane, the lane-level jam distribution would be [1.0].

Using lane connectivity information obtained from the map, the server 240 calculates the probability of traffic jam being in a lane using Equation 1 above. For example, for the lane 111, the initial probability of traffic jam being in the lane 111 is 0.33. The next lane weight is the probability of traffic jam being in the lane 121, which is 0.05. Thus, the probability of traffic jam being in the lane 111 is 0.7*0.33*0.05=0.01. Similarly, for the lane 113, the initial probability of traffic jam being in the lane 113 is 0.33. The next lane weight is the probability of traffic jam being in the lane 123, which is 0.05. Thus, the probability of traffic jam being in the lane 113 is 0.7*0.33*0.05=0.01. For the lane 115, the initial probability of traffic jam being in the lane 115 is 0.33. The next lane weight is the probability of traffic jam being in the lane 131, which is 1. Thus, the probability of traffic jam being in the lane 115 is 0.7*0.33*1.0=0.23. Because the sum of probabilities needs to be 1, the server 240 pads and normalizes the computed probabilities of [0.01, 0.01, 0.23] and obtains updated lane-level jam distribution of [0.04, 0.04, 0.92].

Referring back to FIG. 3, in step 350, the server may transmit the lane-level traffic jam distribution to vehicles approaching the traffic jam area.

By referring to FIG. 1B, the server 240 may transmit the information about the updated lane-level traffic jam distribution to connected vehicles approaching the traffic jam section 140, and the connected vehicles approaching the traffic jam section 140 may autonomously drive to divert the lane having a traffic jam. In some embodiments, the connected vehicles that received the updated lane-level traffic jam distribution from the server 240 may display lane-level traffic jam distribution on an output device, for example, the head-unit of the vehicle, or the navigation app of the smartphone of a user in the vehicle, as illustrated in FIG. 1C.

In some embodiments, the server 240 may identify a lane having a traffic jam based on the lane-level traffic jam distribution and transmit information on the identified lane to vehicles approaching the traffic jam section. For example, based on the lane-level traffic jam distribution, the server 240 identifies the lane 115 as the lane having the traffic jam and transmit the information about the lane 115 to connected vehicles approaching the traffic jam section 140.

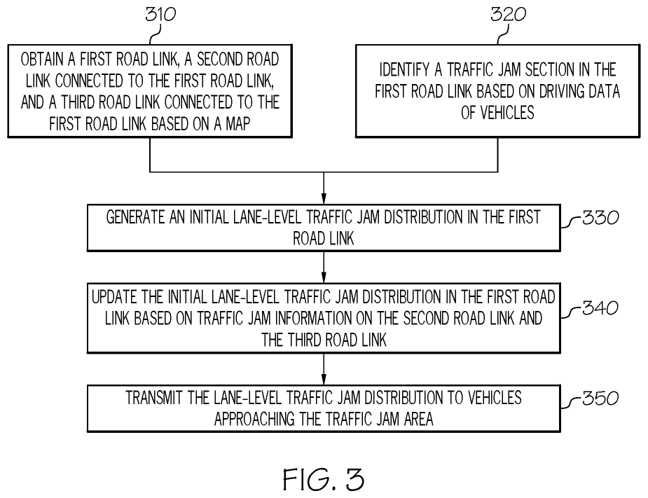

FIG. 4A depicts estimating a probability of traffic jam in each of the lanes using routes of connected vehicles, according to one or more embodiments shown and described herein.

In FIG. 4A, the server 240 may identify that the first road link 110 has a traffic jam close to the end of the first road link 110 based on driving data of connected vehicles in the first road link 110. The server 240 may estimate lane-level traffic jam distribution that includes a probability of traffic jam in each of the lanes 111, 113, 115 of the first road link 110. The server 240 may generate an initial lane-level traffic jam distribution that may have equal probability of traffic jam in each of the lanes 101, 103, 105, i.e., [0.33, 0.33, 0.33]. In this example, in contrast with the example of FIG. 1B, the server 240 determines that the third road link 130 is not congested based on driving data of connected vehicles in the third road link 130.

In embodiments, the server may calculate a percentage of vehicles that were in a traffic jam in the traffic jam section 140 and traveled over a certain next road link out of vehicles that were in the traffic jam in the traffic jam section 140. Specifically, the vehicles that were in the traffic jam in the first road link 110 may take either the second road link 120 or the third road link 130. The server 240 may calculate a percentage of vehicles that were in a traffic jam in the traffic jam section 140 and traveled over the third road link 130 out of vehicles that were in the traffic jam in the traffic jam section 140. If the percentage is greater than a threshold value, e.g., almost all of the connected vehicles in the traffic jam took the third road link 130, the server 240 may determine that the traffic jam in the first road link 110 is likely to be in the lane connected to the third road link 130. Because the lane 115 is connected to the third road link 130, the server 240 may determine that the traffic jam in the first road link 110 is likely to be in the lane 115. The server 240 may determine that lanes that are not connected to the third road link 130 will have low probability of having a traffic jam therein.

The server 240 may calculate a percentage of vehicles that were in a traffic jam in the traffic jam section 140 and traveled over the second road link 120 out of vehicles that were in the traffic jam in the traffic jam section 140. In this case, the percentage is not greater than the threshold value, e.g., most of the connected vehicles in the traffic jam did not take the second road link 120. The server 240 may determine that the traffic jam in the first road link 110 is not likely to be in the lane connected to the second road link 120. Thus, the server 240 may determine that the traffic jam in the first road link 110 is not likely to be in the lanes 111 and 113 that are connected to the second road link 120. In this, regard, the server 240 may obtain updated lane-level jam distribution of [0.05, 0.05, 0.95], which represents probability of a traffic jam being in each of the lanes 111, 113, 115. That is, the lane 115 has 95% of having a traffic jam and the lanes 111 and 113 have 5% of having a traffic jam.

FIG. 4B depicts estimating a probability of traffic jam in each of the lanes using routes of connected vehicles, according to one or more embodiments shown and described herein.

In FIG. 4B, the server 240 may identify that the first road link 110 has a traffic jam close to the beginning of the first road link 110 based on driving data of connected vehicles in the first road link 110. The server 240 may estimate lane-level traffic jam distribution that includes a probability of having a traffic jam in each of the lanes 111, 113, 115 of the first road link 110. The server 240 may generate an initial lane-level traffic jam distribution that may have equal probability of traffic jam in each of the lanes 111, 113, 115, i.e., [0.33, 0.33, 0.33]. The server 240 determines that the third road link 130 is not congested based on driving data of connected vehicles in the third road link 130.

In embodiments, the server may calculate a percentage of vehicles that enter the first road link 110 and are trapped in a traffic jam in the traffic jam section 140 out of vehicles that previously traveled over the third road link 130. Specifically, the vehicles that previously traveled in the third road link 130 may enter a lane with a traffic jam or a lane without a traffic jam. If the percentage is greater than a threshold value, e.g., almost all of the connected vehicles that previously traveled in the third road link 130 ended up being trapped in a traffic jam in the traffic jam section 140, the server 240 may determine that the traffic jam in the first road link 110 is likely to be in the lane connected to the third road link 130. Because the lane 115 is connected to the third road link 130, the server 240 may determine that the traffic jam in the first road link 110 is likely to be in the lane 115. The server 240 may determine that lanes that are not connected to the third road link 130 will have low probability of having a traffic jam therein.

The server 240 may calculate a percentage of vehicles that enter the first road link 110 and are trapped in a traffic jam in the traffic jam section 140 out of vehicles that previously traveled over the second road link 120. In this case, the ratio is not greater than the threshold value, e.g., most of the connected vehicles previously traveled in the second road link 120 did not end up being trapped in a traffic jam in the traffic jam section 140. Then, the server 240 may determine that the traffic jam in the first road link 110 is not likely to be in the lane connected to the second road link 120. Thus, the server 240 may determine that the traffic jam in the first road link 110 is not likely to be in the lanes 111 and 113 that are connected to the second road link 120. In this, regard, the server 240 may obtain updated lane-level jam distribution of [0.05, 0.05, 0.95], which represents probability of a traffic jam being in each of the lanes 111, 113, 115. That is, the lane 115 has 95% of having a traffic jam and the lanes 111 and 113 have 5% of having a traffic jam.

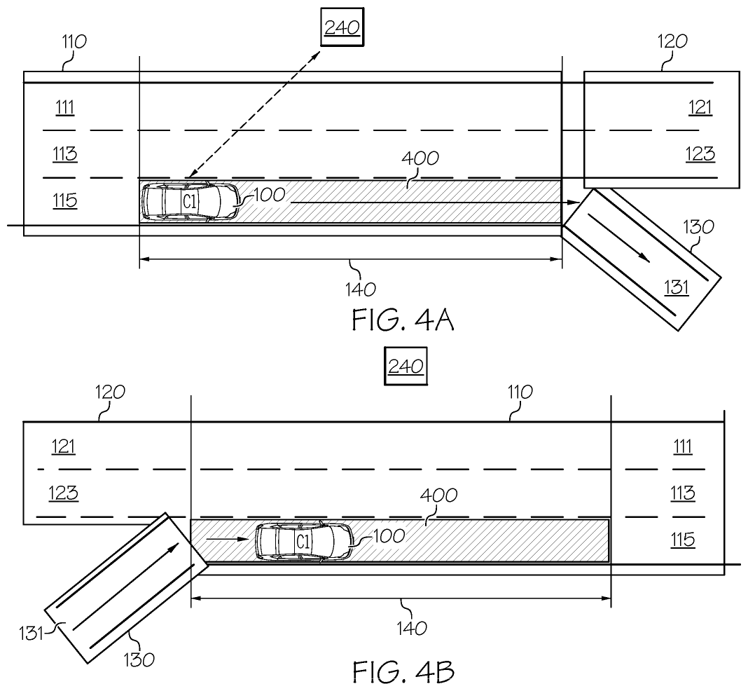

FIG. 5 depicts estimating a probability of traffic jam in each of the lanes using lane connectivity information and lane change signals of connected vehicles, according to one or more embodiments shown and described herein.

In FIG. 5, the connected vehicle 100 is driving in a first road link 510 including lanes 511, 513, 515, 517. The connected vehicle 100 is approaching a traffic jam section 502. The lanes 511, 513, 515 are lanes for going straight and the lane 517 is a lane for a right turn. The server 240 may determine that the connected vehicle 100 is approaching the traffic jam section 502 based on the location of the connected vehicle 100. Although FIG. 5 depicts that the connected vehicle 100 is in the lane 513 and the traffic jam 500 is located in the lane 513, the connected vehicle 100 and the server 240 do not have information that the connected vehicle 100 and the traffic jam 500 are in the lane 513. The server 240 may monitor driving behavior of connected vehicles approaching the traffic jam section 502. For example, the server 240 received driving data from the connected vehicle 100 that the connected vehicle 100 approaching the traffic jam section 502 changes lanes to the right and continues to drive straight.

Because the connected vehicle 100 changed lanes to right after hitting the traffic jam, the traffic jam may be on the lanes 511 or 513. If the traffic jam was on the lane 515, the connected vehicle 100 could not go straight after changing lanes to the right. Thus, the lane-level traffic jam distribution 540 may be [0.45, 0.45, 0.05, 0.05] in which the lanes 515 and 517 have the minimum probability of having a traffic jam therein and the lanes 511 and 513 have the highest probability of having a traffic jam therein.

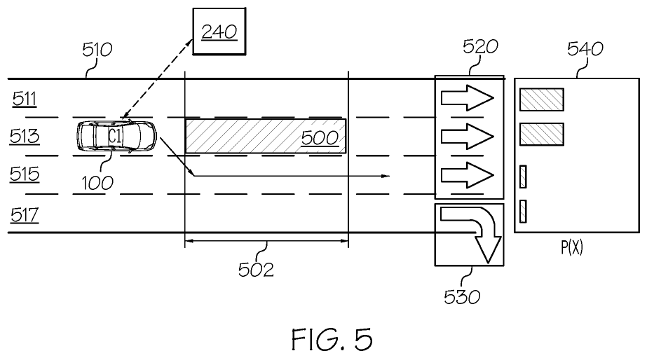

FIG. 6 depicts estimating a probability of traffic jam in each of the lanes using lane connectivity information and lane change signals of connected vehicles, according to one or more embodiments shown and described herein.

In FIG. 6, the connected vehicle 100 is driving in a first road link 610 including lanes 611, 613, 615, 617. The connected vehicle 100 is approaching a traffic jam section 602. The lanes 611, 613, 615 are connected to the straight lanes of the second road link 620 and the lane 617 is connected to the curved lane of the third road link 630. The server 240 may determine that the connected vehicle 100 is approaching the traffic jam section 602 based on the location of the connected vehicle 100. Although FIG. 6 depicts that the connected vehicle 100 is in the lane 613 and the traffic jam 600 is located in the lane 613, the connected vehicle 100 and the server 240 do not have information that the connected vehicle 100 and the traffic jam 600 are in the lane 613. The server 240 may monitor driving behavior of connected vehicles approaching the traffic jam section 602. For example, the server 240 received driving data from the connected vehicle 100 that the connected vehicle 100 drove straight before entering the first road link 610 and approached a traffic jam, changed lanes to the left, and continued to drive straight.

Because the connected vehicle 100 changed lanes to the left after hitting the traffic jam, the traffic jam may be on the lanes 613 or 615. The traffic jam cannot be in lane 611 because the connected vehicle 100 changed lanes to the left after hitting the traffic jam. The traffic jam cannot be in lane 617 because the connected vehicle 100 drove straight before entering the first road link 610. Thus, the lane-level traffic jam distribution 640 may be [0.05, 0.45, 0.45, 0.05] in which the lanes 611 and 617 have the minimum probability of having a traffic jam therein and the lanes 613 and 615 have the highest probability of having a traffic jam therein.

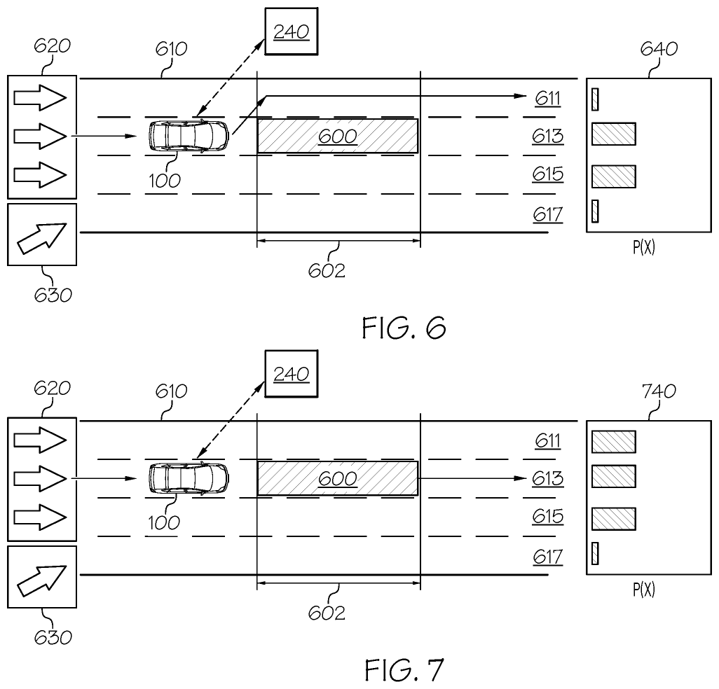

FIG. 7 depicts estimating a probability of traffic jam in each of the lanes using lane connectivity information and lane change signals of connected vehicles, according to one or more embodiments shown and described herein.

In FIG. 7, the connected vehicle 100 is driving in a first road link 610 including lanes 611, 613, 615, 617. The connected vehicle 100 is approaching a traffic jam section 602. The lanes 611, 613, 615 are connected to the straight lanes of the second road link 620 and the lane 617 is connected to the curved lane of the third road link 630. The server 240 may determine that the connected vehicle 100 is approaching the traffic jam section 602 based on the location of the connected vehicle 100. Although FIG. 7 depicts that the connected vehicle 100 is in the lane 613 and the traffic jam 600 is located in the lane 613, the connected vehicle 100 and the server 240 do not have information that the connected vehicle 100 and the traffic jam 600 are in the lane 613. The server 240 may monitor driving behavior of connected vehicles approaching the traffic jam section 602. For example, the server 240 received driving data from the connected vehicle 100 that the connected vehicle 100 drove straight before entering the first road link 610, slew down due to a traffic jam, and continued to drive straight without changing lanes.

The traffic jam cannot be in lane 617 because the connected vehicle 100 drove straight before entering the first road link 610. Because the connected vehicle 100 did not change lanes, the server 240 may determine that the traffic jam can be in lanes 611, 613, or 615 with equal distribution based on the driving data of the connected vehicle 100. Thus, the lane-level traffic jam distribution 740 may be [0.32, 0.32, 0.32, 0.04] in which the lane 617 has the minimum probability of having a traffic jam therein and the lanes 611, 613, and 615 have the highest probability of having a traffic jam therein.

It should be understood that embodiments described herein are directed to methods and systems for estimating lane-level traffic jam, according to one or more embodiments shown and described herein. The system and method obtain a first road link, a second road link connected to the first road link, and a third road link connected to the first road link based on a map; identify a traffic jam section in the first road link based on driving data of vehicles; generate an initial lane-level traffic jam distribution in the first road link; update the initial lane-level traffic jam distribution in the first road link based on traffic jam information on the second road link and the third road link; and transmit the lane-level traffic jam distribution to vehicles approaching the traffic jam section

According to the present disclosure, the present system identifies lane ID of a traffic jam by analyzing lane connectivity data, vehicle rout information, and/or congestion information in adjacent lanes. The present system identifies lane ID of a traffic jam without requiring lane ID of vehicles.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system comprising:
one or more processors programmed to:
obtain a first road link, a second road link connected to the first road link, and a third road link connected to the first road link based on a map;
identify a traffic jam section in the first road link based on driving data of vehicles;
generate an initial lane-level traffic jam distribution in the first road link;
update the initial lane-level traffic jam distribution in the first road link based on traffic jam information on the second road link and the third road link; and
transmit the lane-level traffic jam distribution to vehicles approaching the traffic jam section.

2. The system of claim 1, wherein:
the first road link includes a plurality of lanes;
the initial lane-level traffic jam distribution includes a probability of traffic jam in each of the plurality of lanes; and
updating the initial lane-level traffic jam distribution includes updating the probability of traffic jam in each of the plurality of lanes.

3. The system of claim 2, wherein the one or more processors are further programmed to:
determine that the second road link does not include a traffic jam and the third road link includes a traffic jam; and
calculate the probability of traffic jam in a lane of the first road link that is connected to the third road link based on the determination that the second road link does not include a traffic jam and the third road link includes a traffic jam.

4. The system of claim 2, wherein the one or more processors are further programmed to:
determine that a front of the traffic jam section is close to an end of the first road link and a beginning of third road link is congested; and
calculate the probability of traffic jam in a lane of the first road link that is connected to the third road link based on the determination that the front of the traffic jam section is close to an end of the first road link and the beginning of third road link is congested.

5. The system of claim 2, wherein the one or more processors are further programmed to:
determine that a back of the traffic jam section is close to a beginning of the first road link and an end of third road link connected to the beginning of the first road link is congested; and
calculate the probability of traffic jam in a lane of the first road link that is connected to the third road link based on the determination that the back of the traffic jam section is close to the beginning of the first road link and the end of third road link is congested.

6. The system of claim 2, wherein the one or more processors are further programmed to:
update the initial lane-level traffic jam distribution in the first road link based on a ratio of a number of vehicles that were in a traffic jam in the first road link to a number of vehicles that exited the traffic jam and entered the third road link.

7. The system of claim 6, wherein the one or more processors are further programmed to:
determine that a front of the traffic jam section is close to an end of the first road link;
determine whether the ratio is greater than a threshold; and
calculate the probability of traffic jam in a lane of the first road link that is connected to the third road link based on the determination that the ratio is greater than the threshold.

8. The system of claim 2, wherein the one or more processors are further programmed to:
update the initial lane-level traffic jam distribution in the first road link based on a percentage of vehicles that enter the first road link and are trapped in a traffic jam out of vehicles that traveled in the third road link.

9. The system of claim 8, wherein the one or more processors are further programmed to:
determine that a back of the traffic jam section is close to a beginning of the first road link;
determine whether the percentage is greater than a threshold; and
calculate the probability of traffic jam in a lane of the first road link that is connected to the third road link based on the determination that the percentage is greater than the threshold.

10. The system of claim 1, wherein the one or more processors are further programmed to:
obtain information on lane changes of a vehicle in the first road link;
obtain information on whether the vehicle enters the second road link or the third road link after the lane changes; and
update the initial lane-level traffic jam distribution in the first road link further based on the information on lane changes and the information on whether the vehicle enters the second road link or the third road link.

11. The system of claim 1, wherein the one or more processors are further programmed to:
obtain information on lane changes of a vehicle in the first road link;
obtain information on whether the vehicle was in the second road link or the third road link before driving in the first road link; and
update the initial lane-level traffic jam distribution in the first road link further based on the information on lane changes and the information on whether the vehicle was in the second road link or the third road link before driving in the first road link.

12. A method for determining lane-level traffic, the method comprising:
obtaining a first road link, a second road link connected to the first road link, and a third road link connected to the first road link based on a map;
identifying a traffic jam section in the first road link based on driving data of vehicles;
generating an initial lane-level traffic jam distribution in the first road link;
updating the initial lane-level traffic jam distribution in the first road link based on traffic jam information on the second road link and the third road link; and
transmitting the lane-level traffic jam distribution to vehicles approaching the traffic jam section.

13. The method of claim 12, wherein:
the first road link includes a plurality of lanes;
the initial lane-level traffic jam distribution includes a probability of traffic jam in each of the plurality of lanes; and
updating the initial lane-level traffic jam distribution includes updating the probability of traffic jam in each of the plurality of lanes.

14. The method of claim 13, further comprising:
determining that the second road link does not include a traffic jam and the third road link includes a traffic jam; and
calculating the probability of traffic jam in a lane of the first road link that is connected to the third road link based on the determination that the second road link does not include a traffic jam and the third road link includes a traffic jam.

15. The method of claim 13, further comprising:
determining that a front of the traffic jam section is close to an end of the first road link and a beginning of third road link is congested; and
calculating the probability of traffic jam in a lane of the first road link that is connected to the third road link based on the determination that the front of the traffic jam section is close to an end of the first road link and the beginning of third road link is congested.

16. The method of claim 13, further comprising:
determining that a back of the traffic jam section is close to a beginning of the first road link and an end of third road link connected to the beginning of the first road link is congested; and
calculating the probability of traffic jam in a lane of the first road link that is connected to the third road link based on the determination that the back of the traffic jam section is close to the beginning of the first road link and the end of third road link is congested.

17. The method of claim 13, further comprising:
updating the initial lane-level traffic jam distribution in the first road link based on a ratio of a number of vehicles that were in a traffic jam in the first road link to a number of vehicles that exited the traffic jam and entered the third road link.

18. The method of claim 17, further comprising:
determining that a front of the traffic jam section is close to an end of the first road link;
determining whether the ratio is greater than a threshold; and
calculating the probability of traffic jam in a lane of the first road link that is connected to the third road link based on the determination that the ratio is greater than the threshold.

19. The method of claim 12, further comprising:
obtaining information on lane changes of a vehicle in the first road link;
obtaining information on whether the vehicle enters the second road link or the third road link after the lane changes; and
updating the initial lane-level traffic jam distribution in the first road link further based on the information on lane changes and the information on whether the vehicle enters the second road link or the third road link.

20. The method of claim 12, further comprising:
obtaining information on lane changes of a vehicle in the first road link;
obtaining information on whether the vehicle was in the second road link or the third road link before driving in the first road link; and
updating the initial lane-level traffic jam distribution in the first road link further based on the information on lane changes and the information on whether the vehicle was in the second road link or the third road link before driving in the first road link.
